(19) United States
(12) Patent Application Publication
(10) Pub. No.: US 2011/0079663 A1
(43) Pub. Date: Apr. 7, 2011

(54) SELF-CONTAINED, SPRAYABLE, SILYL TERMINATED ADHESIVE SYSTEMS

(75) Inventor: Raul J. Cabrera, Manetta, GA (US)

(73) Assignee: 3M Innovative Properties Company

(21) Appl. No.: 12/571,525

(22) Filed: Oct. 1, 2009

(51) Int. Cl. B05B 7/24; C09J 11/06

(52) U.S. Cl. 239/337; 524/378

(57) ABSTRACT

Self-contained sprayable adhesive systems are described. Such systems include a sprayable adhesive composition comprising a silyl terminated elastomeric adhesive and a propellant contained within a canister. The system also includes a spray nozzle connected to the canister.

### FIELD

The present disclosure relates to self-contained, sprayable adhesive compositions. Such compositions include a silyl terminated elastomeric adhesive and a propellant.

### BACKGROUND

Generally, protective or decorative substrates have been applied to a support using a wide variety of means including mechanical fasteners (e.g., nails and screws). Although adhesives have also been used, the application of commercially available adhesives has been cumbersome and messy, generally requiring the application of the adhesives as pre-formed sheets or as liquids rolled or brushed on to one or both of the mating surfaces. Typical liquid adhesives used in these applications are both viscous and tacky, presenting numerous handling problems.

Silyl terminated elastomers such as silyl terminated polyether and silyl terminated polyurethane have been used as coating and sealants. In such applications, the silyl terminated elastomers are often dispersed in water or an organic solvent. In addition to being applied by rollers or brushes, such coatings have been applied using complex external spray systems. In such systems, the elastomer is fed from a pail or drum to a spray gun at a fluid gage pressure of about 70 to 100 kPa (about 10 to 15 psig). High pressure air (gage pressure of 200 to 700 kPa (about 30 to 100 psig) is fed through a separate line from an air compressor or other high pressure source to the gun. The high pressure air is then used to atomize the elastomer as it is ejected from the spray gun. While such a system may work for some applications, it is ill-suited for applications requiring portability. In addition, the requirement of a separate high pressure air source is a significant limitation.

### SUMMARY

Briefly, in one aspect, the present disclosure provides a self-contained sprayable adhesive system. The self-contained sprayable adhesive system comprises a pressurized canister connected to a spray nozzle, and a sprayable adhesive composition contained within the canister. The sprayable adhesive system comprises a silyl terminated elastomeric adhesive and a propellant. In some embodiments, the spray nozzle is connected directly to the pressurized canister. In some embodiments, a hose connects the spray nozzle to the pressurized canister via a hose. In some embodiments, the pressure in the pressurized canister is between 200 and 900 kPa, inclusive.

In some embodiments, the silyl terminated elastomeric adhesive comprises a silyl terminated polyether. In some embodiments, the silyl terminated elastomeric adhesive comprises a silyl terminated polyurethane. In some embodiments, the sprayable adhesive composition comprises 50 to 80% by weight of the silyl terminated elastomeric adhesive based on the total weight of the silyl terminated elastomeric adhesive and the propellant.

In some embodiments, the propellant comprises a blend of a liquefied petroleum gas and a dialkyl ether. In some embodiments, the liquefied petroleum gas comprises at least one of isobutane and propane. In some embodiments, the dialkyl ether comprises dimethyl ether. In some embodiments, the propellant comprises 30 to 50 parts by weight of a liquefied petroleum gas and 50 to 70 parts by weight of a dialkyl ether. In some embodiments, the propellant comprises 20 to 25 parts by weight isobutane, 15 to 20 parts by weight propane, and to 55 to 65 parts by weight of dimethyl ether.

In another aspect, the present disclosure provides a sprayable adhesive composition comprising a silyl terminated elastomeric adhesive and a propellant comprising a blend of a liquefied petroleum gas and a dialkyl ether. In some embodiments, the silyl terminated elastomeric adhesive comprises a silyl terminated polyether. In some embodiments, the silyl terminated elastomeric adhesive comprises a silyl terminated polyurethane.

In some embodiments, the sprayable adhesive composition comprises 60 to 70% by weight of the silyl terminated elastomeric adhesive based on the total weight of the silyl terminated elastomeric adhesive and the propellant. In some embodiments, the propellant comprises 20 to 25 parts by weight isobutane, 15 to 20 parts by weight propane, and to 55 to 65 parts by weight of dimethyl ether.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates a sprayable adhesive system according to one embodiment of the present disclosure.

FIG. 2 illustrates a sprayable adhesive system according to another embodiment of the present disclosure.

### DETAILED DESCRIPTION

The present disclosure relates to sprayable adhesive compositions and self-contained sprayable adhesive systems comprising such compositions. The self-contained sprayable adhesive systems comprise a canister containing the sprayable adhesive composition. Generally, any known canister may be used, provided the materials of the canister are compatible with the sprayable adhesive compositions. In order to spray the adhesive, the canisters are pressurized; thus, the canister design and materials should also be selected to withstand the desired pressure.

Typical pressures range from 200 to 900 kPa, inclusive. In some embodiments, the pressure within the canister is at least 300 kPa, or even at least 400 kPa. In some embodiments, the pressure within the canister is no greater than 700 kPa, or even no greater than 500 kPa. In some embodiments, the canisters have a service pressure of 2 to 3 MPa, e.g., about 2.7 MPa; a test pressure of 3 to 4 MPa (e.g., about 3.5 MPa); and a burst pressure of 6 to 8 MPa (e.g., about 7 MPa). Commercially available canisters include those from, e.g., Worthington Cylinders, Columbus, Ohio; Amtrol, Inc., West Warwick, R.I.; and Manchester Tank, Chicago, Ill.

Generally, the size and shape of the canister may be selected according to know design considerations including desired volume, weight, ergonomics and cost. Common canisters suitable for some embodiments of the present disclosure include cylinders and tanks Typical materials for canister construction include metals, e.g., steel and stainless steel. In some embodiments, the interior surface of the canister may be coated with a material to minimize or eliminate any adverse interactions between the adhesive composition and the canister, and/or to aid in filling, dispensing, or cleaning the canister. Similarly, coatings may be applied to the outside the canister to, e.g., protect the exterior of the canister from the adhesive composition, the environment or rough handling. Coatings may also be used to minimize or eliminate the risk of static discharge during the use and handling of the canister.

The sprayable adhesive systems of the present disclosure also include a spray nozzle connected to the canister. Generally, any known spray nozzle may be used including, e.g., those available from Spraying Systems, Incorporated, Wheaton, Ill. Exemplary spray nozzles include spray guns which include a spray tip having a trigger control.

Unlike other spray systems, the self-contained sprayable adhesive systems of the present disclosure do not require an external source of pressurized air to force the adhesive through the nozzle and atomize the material being sprayed. Rather, the pressure generated by the propellants themselves is sufficient to force the sprayable adhesive composition through the spray nozzle to form a mist spray, i.e., a spray comprising individual drops.

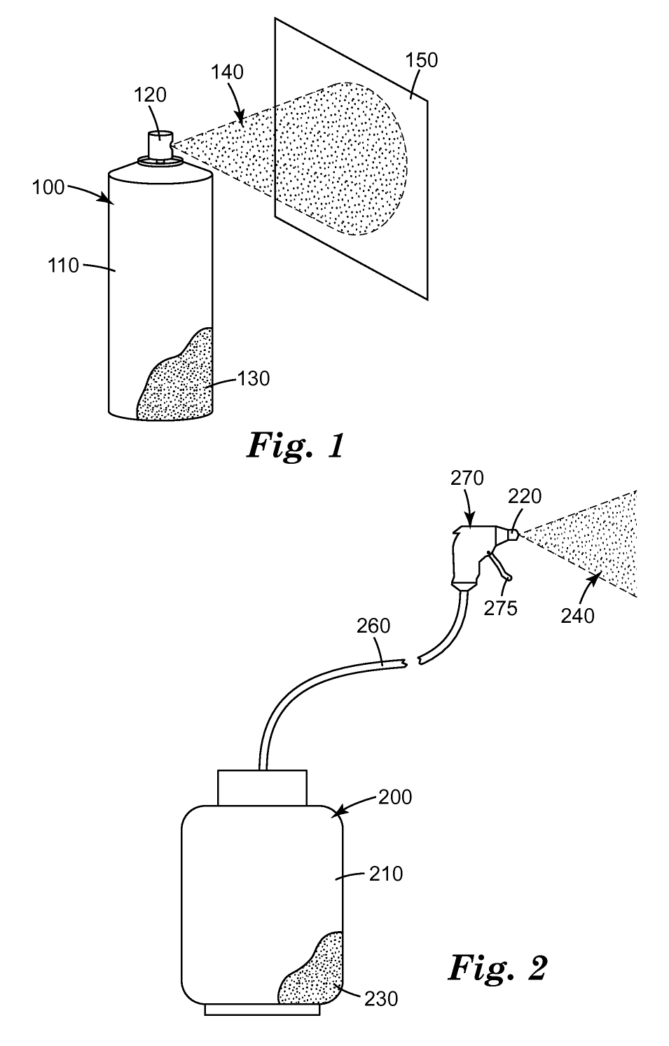

In some embodiments, the spray nozzle is connected directly to the canister. For example, as shown in FIG. 1, spray system 100 includes canister 110 directly connected to nozzle 120. Sprayable adhesive composition 130 is contained within canister 110 and may be applied through spray nozzle 120 as spray 140 to substrate 150. In some embodiments, spray nozzle 120 may be activated by depressing nozzle 120 toward canister 110, opening a valve (not shown) and permitting the sprayable adhesive composition to flow under the force of the pressure within the canister, through nozzle, to be emitted as a spray.

Referring to FIG. 2, in some embodiments, spray system 200 includes spray nozzle 220 connected to the canister 210 via hose 260. In some embodiments, spray nozzle 220 is part of spray gun 270, which includes trigger 275. When trigger 275 is activated, a valve (not shown) is opened and adhesive composition 230, driven by the pressure within canister 210, flows from canister 210 to spray nozzle 220 through hose 260 forming spray 240. When trigger 275 is released the flow of adhesive composition 230 stops.

Generally, the sprayable adhesive composition comprises a silyl terminated elastomeric adhesive and a propellant. In some embodiments, the silyl terminated elastomeric adhesive comprises a silyl terminated polyether (“STP”) or a silyl terminated polyurethane (“SPUR”). Such materials are commercially available including, e.g., MANUS-BOND 75-AM, available from Manus Products, Incorporated, Waconia, Minn.; and those available under the trade designation SPUR+ from Momentive Performance Materials, Friendly, W. Va.

In some embodiments, the sprayable adhesive composition comprises 50 to 80% by weight silyl terminated elastomeric adhesive, e.g., 50 to 70% by weight, or even 60 to 70% by weight silyl terminated elastomeric adhesive, based on the total weight of the silyl terminated elastomeric adhesive and the propellant.

Generally, any propellant compatible with both the silyl terminated elastomeric adhesive and the mechanical components of the spray system (e.g., the canister, the spray nozzle, and the optional hose) may be used. In some embodiments, the propellant may comprise a blend of materials to achieve the desired compatibility, pressure, and spray characteristics.

In some embodiments, the propellant comprises a blend of at least one liquefied petroleum gas (“LPG”) and a dialkyl ether. Generally, a liquefied petroleum gas is a saturated hydrocarbon selected to be a liquid at the pressure within the canister, and a vapor at atmospheric pressure. Exemplary saturated hydrocarbons include propane and butane (e.g., isobutane and n-butane). In some embodiments, blends of liquefied petroleum gases may be useful, e.g., blends of propane and isobutane. For example, in some embodiments, the propellant comprises a blend of propane and isobutane at a weight ratio of between 1:1 and 1:1.7, inclusive, e.g., between 1:1.2 and 1:1.5, inclusive, or even between 1:1.3 and 1:1.4, inclusive.

In some embodiments, a dialkyl ether may be used a propellant, typically n combination with one or more liquefied petroleum gases. Exemplary dialkyl ethers include dimethyl ether. In some embodiments, the propellant comprises 30 to 50 parts by weight of a liquefied petroleum gas and 50 to 70 parts by weight of a dialkyl ether; e.g., 35 to 45 parts by weight of a liquefied petroleum gas and 55 to 65 parts by weight of a dialkyl ether. In some embodiments, the propellant consists of 30 to 50 parts by weight of a liquefied petroleum gas and 50 to 70 parts by weight of a dialkyl ether; e.g., 35 to 45 parts by weight of a liquefied petroleum gas and 55 to 65 parts by weight of a dialkyl ether. In each of these embodiments, in some embodiments, the dialkyl ether is dimethyl ether.

In some embodiments, the propellant comprises 20 to 25 parts by weight isobutane, 15 to 20 parts by weight propane, and to 55 to 65 parts by weight of dimethyl ether. In some embodiments, the propellant consists of 20 to 25 parts by weight isobutane, 15 to 20 parts by weight propane, and to 55 to 65 parts by weight of dimethyl ether.

Propellants and propellant blends are commercially available from a variety of sources including, e.g., Diversified CPC International, Incorporated, Channahon, Ill.; Aeropres Corporation, Shreveport La.; and Technical Propellants, Inc, Morris, Ill. As a consequence of their manufacturing process, as supplied, the commercially available propellants may contain small, residual amounts of saturated hydrocarbons such as ethylene and propylene.

### EXAMPLES

### Example 1

An elastomeric adhesive (MANUS-BOND 75-AM, obtained from Manus Products, Incorporated, Waconia, Minn., and believed to be a silyl terminated polyether) was charged into a 7.2 liter (1.9 gallon) steel canister, via the inlet at the top of the canister using a piston pump equipped with an air motor. Next, a propellant was introduced into the canister in the same manner. The propellant (obtained from Diversified CPC International, Incorporated, Channahon, Ill.) was a blend of about 40 parts by weight of a liquefied petroleum gas (approximately 23 parts by weight isobutane 17 parts by weight propane) and 60 parts by weight dimethyl ether. The resulting mixture in the canister contained 67 wt. % of elastomeric adhesive and 33 wt. % of propellant, and had an internal pressure of 483 kPa (70 psi).

Next, a spray gun equipped with a spray nozzle having a trigger control (“23L GunJet” obtained from Spraying Systems, Incorporated, Wheaton, Ill.) was attached to the canister inlet by means of a rubber hose (a nylon, silicone-free tube, with black synthetic rubber and braided synthetic yarn reinforcement, obtained from Pioneer Rubber & Gasket Co., Tucker, Ga.). The spray gun was rated for a maximum operating pressure of 1.7 MPa (250 psi) and a flow rate capacity of up to 19 liters per minute (5 gallons per minute). The spray gun was equipped with a 9501 spray tip having a 95 degree spray angle, an equivalent orifice size of 0.66 mm (0.026 inches), and a flow rate of 0.4 liters per minute (0.1 gallons per minute) at 275 kPa (40 psig) pressure.

The canister was thoroughly agitated prior to spraying the adhesive. When the trigger was activated, adhesive flowed from the canister, through the hose, and was discharged through the spray nozzle of the spray gun. The desired mist spray, which consisted of individual droplets of the silyl terminated elastomer, was formed.

Adhesive was then sprayed onto one side of each of the following first substrates: wood flooring underlayment, plywood, concrete, aluminum, stainless steel, fiberboard, and particle board. Although discharged as a mist of individual droplets, when applied to the substrates the adhesive formed a uniform coating on the sprayed surface of the substrate.

After waiting between 2 and 5 minutes for the sprayed coating to dry and become tacky, a smaller piece of each of the following second substrate materials was joined to the adhesive surface of each of the first substrates: carpet tiles, vinyl tiles, plywood, red oak wood plank flooring material, aluminum, stainless steel, polyethylene, polypropylene, polycarbonate, and a high pressure laminate (“HPL”) veneer. The adhesively joined substrates were pressed together with firm hand pressure using a rubber “J” roller. This procedure is referred to as “one-sided application.”

The bonded assemblies were cured for 24 hours at room temperature. The cured assemblies were then pulled apart by hand. Excellent adhesive force between the substrates was observed. Traces of the substrate materials still adhered to the adhesive indicated substrate failure. When an attempt was made to pry these remaining pieces apart with a screwdriver the substrates broke providing further evidence of substrate failure.

### Example 2

This evaluation procedure was repeated using a “two sided application” technique in which a surface of both the first substrate and the second surface were sprayed with adhesive. The adhesive was allowed to dry and become tacky, and then the substrates were joined, adhesive-coated surface to adhesive-coated surface. After curing for 24 hours at room temperature, these bonded assemblies were tested as described above, with the same results, i.e., substrate failure.

### Example 3

A silyl terminated elastomeric adhesive (SPUR+ 3100HM, obtained from Momentive Performance materials, Friendly, W. Va., and believed to be a silyl terminated polyurethane (SPUR)) was charged into a 7.2 liter (1.9 gallon) steel canister, via the inlet at the top of the canister using a piston pump equipped with an air motor. Next, a propellant was introduced into the canister in the same manner. The propellant (obtained from Diversified CPC International, Incorporated, Channabon, Ill.) was a blend of about 40 parts by weight of liquefied petroleum gas (approximately 23 parts by weight isobutane, 17 parts by weight propane) and 60 parts by weight dimethyl ether. The resulting mixture in the canister contained 67 wt % of the silyl terminated elastomeric adhesive and 33 wt % of the propellant, and had an internal pressure of 483 kPa (70 psi).

The one sided application test procedures described for Example 1 were performed. The canister was thoroughly agitated prior to spraying the adhesive. When the trigger was activated, adhesive flowed from the canister, through the hose, and was discharged through the spray nozzle of the spray gun. The desired mist spray, which consisted of individual droplets of the silyl terminated elastomer, was formed.

Various modifications and alterations of this invention will become apparent to those skilled in the art without departing from the scope and spirit of this invention.

What is claimed is:

1. A self-contained sprayable adhesive system comprising a pressurized canister connected to a spray nozzle, and a sprayable adhesive composition contained within the canister; wherein the sprayable adhesive system comprises a silyl terminated elastomeric adhesive and a propellant.

2. The self-contained sprayable adhesive system of claim 1, wherein the spray nozzle is connected directly to the pressurized canister.

3. The self-contained sprayable adhesive system of claim 1, wherein a hose connects the spray nozzle to the pressurized canister via a hose.

4. The self-contained sprayable adhesive system of claim 1, wherein the pressure in the pressurized canister is between 200 and 900 kPa, inclusive.

5. The self-contained sprayable adhesive system of claim 1, wherein the silyl terminated elastomeric adhesive comprises a silyl terminated polyether.

6. The self-contained sprayable adhesive system of claim 1, wherein the silyl terminated elastomeric adhesive comprises a silyl terminated polyurethane.

7. The self-contained sprayable adhesive system of claim 1, wherein the propellant comprises a blend of a liquefied petroleum gas and a dialkyl ether.

8. The self-contained sprayable adhesive system of claim 7, wherein the liquefied petroleum gas comprises at least one of isobutane and propane.

9. The self-contained sprayable adhesive system of claim 7, wherein the dialkyl ether comprises dimethyl ether.

10. The self-contained sprayable adhesive system of claim 7, wherein the propellant comprises 30 to 50 parts by weight of a liquefied petroleum gas and 50 to 70 parts by weight of a dialkyl ether.

11. The self-contained sprayable adhesive system of claim 10, wherein the propellant comprises 20 to 25 parts by weight isobutane, 15 to 20 parts by weight propane, and to 55 to 65 parts by weight of dimethyl ether.

12. The self-contained sprayable adhesive system of claim 1, wherein the sprayable adhesive composition comprises 50 to 80% by weight of the silyl terminated elastomeric adhesive based on the total weight of the silyl terminated elastomeric adhesive and the propellant.

13. The self-contained sprayable adhesive system of claim 1, wherein the silyl terminated elastomer comprises at least one of a silyl terminated polyether and a silyl terminated polyurethane; and wherein the propellant comprises 30 to 50 parts by weight of a liquefied petroleum gas and 50 to 70 parts by weight of a dialkyl ether.

14. The self-contained sprayable adhesive system of claim 13, wherein the propellant comprises 20 to 25 parts by weight isobutane, 15 to 20 parts by weight propane, and to 55 to 65 parts by weight of dimethyl ether.

15. The self-contained sprayable adhesive system of claim 13, wherein the sprayable adhesive composition comprises 60 to 70% by weight of the silyl terminated elastomeric adhesive based on the total weight of the silyl terminated elastomeric adhesive and the propellant.

16. A sprayable adhesive composition comprising a silyl terminated elastomeric adhesive and a propellant comprising a blend of a liquefied petroleum gas and a dialkyl ether.

17. The sprayable adhesive composition of claim 16, wherein the silyl terminated elastomeric adhesive comprises a silyl terminated polyether.

18. The sprayable adhesive composition of claim 16, wherein the silyl terminated elastomeric adhesive comprises a silyl terminated polyurethane.

19. The sprayable adhesive composition of claim 16, wherein the sprayable adhesive composition comprises 60 to 70% by weight of the silyl terminated elastomeric adhesive based on the total weight of the silyl terminated elastomeric adhesive and the propellant.

20. The sprayable adhesive system of claim 19, wherein the propellant comprises 20 to 25 parts by weight isobutane, 15 to 20 parts by weight propane, and to 55 to 65 parts by weight of dimethyl ether.
